(19) United States
(12) Patent Application Publication
(10) Pub. No.: US 2026/0167424 A1
(43) Pub. Date: Jun. 18, 2026

(54) ARTICLE STORAGE SYSTEM

(71) Applicant: SEMES CO., LTD., Chungcheongnam-do (KR)

(72) Inventor: Sung Ho LEE, Chungcheongnam-do (KR)

(21) Appl. No.: 19/392,114

(22) Filed: Nov. 17, 2025

(30) Foreign Application Priority Data
Dec. 16, 2024 (KR) 10-2024-0186727

(51) Int. Cl. B65G 1/127; B65G 1/04

(52) U.S. Cl. CPC B65G 1/127; B65G 1/0464; B65G 2201/0297

(57) ABSTRACT

An article storage system is provided, in which a container in which an article is stored is stored. The article storage system comprises a support unit perpendicular to an installation surface, a rotation unit rotated axially in the support unit, and a shelf module provided in the rotation unit so that its arrangement is changed in conjunction with rotation of the rotation unit, accommodating the container.

### CROSS-REFERENCE TO RELATED APPLICATION

This application claims priority from Korean Patent Application No. 10-2024-0186727 filed on Dec. 16, 2024 in the Korean Intellectual Property Office and all the benefits accruing therefrom under 35 U.S.C. 119, the contents of which in its entirety are herein incorporated by reference.

### BACKGROUND

### Technical Field

The present disclosure relates to an article storage system.

### Description of the Related Art

Semiconductor devices or liquid crystal displays are manufactured by repeatedly performing unit processes, such as deposition and etching, on substrates such as semiconductor substrates or glass substrates. These processes are performed sequentially, and the substrates are transferred to process devices in which each process is performed.

Since the substrates are easily defective even by fine dust or particles, the substrates moving between the respective processes should be kept clean. Furthermore, transferring the substrates individually is inefficient. Therefore, the substrates are transferred while being accommodated in containers such as cassettes or Front Open Unifies POD (FOUP).

The respective process devices have different substrate treating capacities and processing times. To solve a problem that occurs due to this issue, an article storage system such as a stocker, a side track buffer, and an under track buffer is used to temporarily store a container.

For example, the side track buffer is provided on a side of a rail along which a transfer device, such as a vehicle, moves. As the transfer device travels along the rail, it can load and unload articles onto and from the side track buffer in a lateral direction of the rail. The under track buffer may be provided so that a vehicle performs a loading and unloading work in a downward direction of the rail.

In this way, the article storage system may be provided so that the transfer device performs the loading and unloading work in the lateral or downward direction of the rail. That is, the stocker, the side track buffer, and the under track buffer are individually installed in a manufacturing plant, and thus efforts to improve space efficiency of the manufacturing plant and efficiency in the loading and unloading work of the transfer device are ongoing.

### BRIEF SUMMARY

An object of the present disclosure is to provide an article storage system that can improve work efficiency of a transfer device and space efficiency of a manufacturing plant.

The objects of the present disclosure are not limited to those mentioned above and additional objects of the present disclosure, which are not mentioned herein, will be clearly understood by those skilled in the art from the following description of the present disclosure.

To achieve the above problem, the article storage system according to one aspect of the present disclosure comprises a support unit perpendicular to an installation surface, a rotation unit rotated axially in the support unit, and a shelf module provided in the rotation unit so that its arrangement is changed in conjunction with rotation of the rotation unit, accommodating the container.

An article storage system in which a container in which an article is stored is stored, the article storage system comprises a support unit perpendicular to a ceiling in a downward direction; a rotation unit rotated axially in the support unit; and a shelf module provided in the rotation unit so that its arrangement is changed in conjunction with rotation of the rotation unit, accommodating the container, wherein the rotation unit includes: a motor rotated at an interval of 45°; and a rotor rotated by being connected to the motor and provided with an extension arm extending in four directions, the shelf module includes: a shelf plate rotated idle in the extension arm; and a shelf base on which the container is loaded, and the shelf base is provided at a position facing a lower portion of each of a first rail and a second rail adjacent to the first rail in an up and down direction and provided in an up and down direction between the first rail and the second rail, so that the container loaded and unloaded from one or more vehicles moving through each of the first rail and the second rail is loaded.

An article storage system in which a container in which an article is stored is stored, the article storage system comprises a support unit perpendicular to a ceiling in a downward direction and provided between a first rail in which a vehicle's moving path is formed and a second rail in which another moving path is formed adjacent to the first rail; a rotation unit rotated axially in the support unit; and a shelf module provided in the rotation unit so that its arrangement is changed in conjunction with rotation of the rotation unit, accommodating the container, wherein the rotation unit includes: a motor rotated at an interval of 45°; a rotor rotated by being connected to the motor and provided with an extension arm including a first arm, a second arm, a third arm and a fourth arm, which are provided in a radial direction, arranged at an interval of 45° and provided with a through hole; an electronic brake provided in the rotor to stop rotation of the rotor rotated by the motor or provided in the rotor to stop rotation of the shelf module rotated in the rotor; and a lock module provided with a fixing pin and inserted into the through hole in accordance with an elongation of the fixing pin to block the rotation of the rotor, or spacing the fixing pin apart from the through hole to allow the rotation of the rotor, and the shelf module includes: a shelf plate rotated idle in the extension arm; a shelf base including a weight located at the center on a lower surface of the shelf plate, provided on an upper surface of the shelf plate, loading the container thereon; and a guider extending upward from the shelf base, having an upper end portion bent outward to guide seating of the container, and including a first guide plate paired at the front and rear of the container and a second guide plate paired on left and right sides of the container.

Details of the other embodiments are included in the detailed description and drawings.

The article storage system according to the present disclosure enables two vehicles to simultaneously perform a loading and unloading work on two rails in the same direction or opposite directions, thereby improving efficiency of a transfer work. The improved efficiency of the transfer work reduces vehicle congestion, thereby increasing efficiency of the overall operation system in a manufacturing plant. Furthermore, the system functions as both a side track buffer and an under track buffer, thereby reducing installation costs and improving space efficiency of the manufacturing plant.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a front view illustrating an article storage system according to the first embodiment of the present disclosure;

FIG. 2 is a front view illustrating a rotation unit and a shelf module of an article storage system according to the first embodiment of the present disclosure;

FIG. 3 is a front view illustrating a shelf module of an article storage system according to the first embodiment of the present disclosure;

FIG. 4 is a perspective view illustrating a shelf module of an article storage system according to the first embodiment of the present disclosure;

FIG. 5 is a side view illustrating a shelf module of an article storage system according to the first embodiment of the present disclosure;

FIG. 6 is a front view illustrating a loading and unloading work according to a first form of an article storage system according to the first embodiment of the present disclosure;

FIG. 7 is a front view illustrating a loading and unloading work according to a second form of an article storage system according to the first embodiment of the present disclosure;

FIG. 8 is a front view illustrating a state in which a rotation unit is rotated in an article storage system according to the first embodiment of the present disclosure;

FIG. 9 is a front view illustrating a state in which an additional loading and unloading work according to a second form of an article storage system according to the first embodiment of the present disclosure is performed;

FIG. 10 is a side view illustrating an article storage system according to the first embodiment of the present disclosure;

FIG. 11 is a front view illustrating an article storage system according to the second embodiment of the present disclosure; and

FIG. 12 is a front view illustrating a loading and unloading work of an article storage system according to the second embodiment of the present disclosure.

### DETAILED DESCRIPTION OF THE DISCLOSURE

Hereinafter, the preferred embodiment of the present disclosure will be described in detail with reference to the accompanying drawings. Advantages and features of the present disclosure and methods of achieving the advantages and features will be apparent from the following embodiments that will be described in more detail with reference to the accompanying drawings. It should be noted, however, that the present disclosure is not limited to the following embodiments, and may be implemented in various forms. The embodiments are provided only to disclose the present disclosure and let those skilled in the art understand the scope of the present disclosure. In the drawings, the embodiments of the present disclosure are defined by the scope of claims. The same reference numerals denote the same elements throughout the specification.

The terms used herein are for the purpose of embodiments, and are not intended to be limit the present disclosure. In the present disclosure, unless referred to the contrary, the singular forms are intended to include the plural forms. The terms “comprises” and/or “comprising” used herein specify the presence of stated elements, steps, operations and/or components but do not preclude the presence or addition of one or more other elements, steps, operations and/or components.

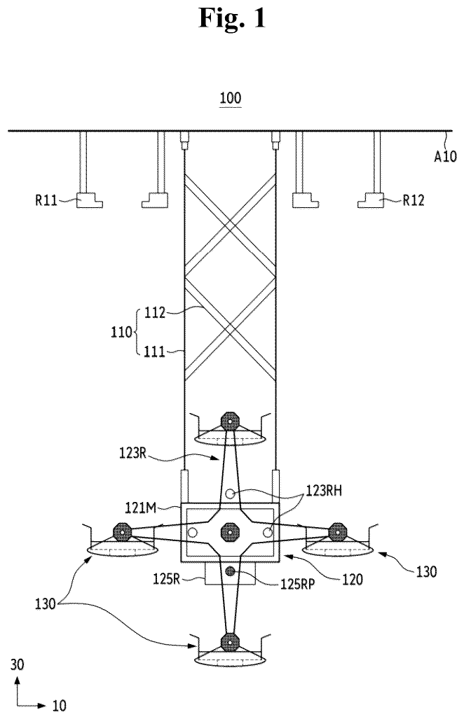

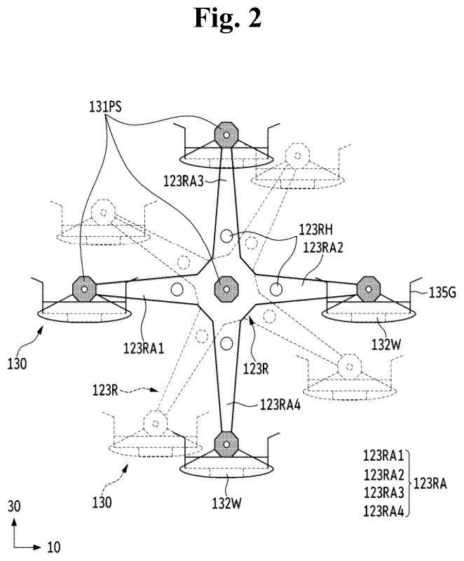

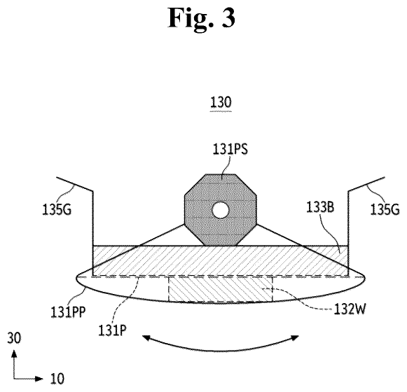

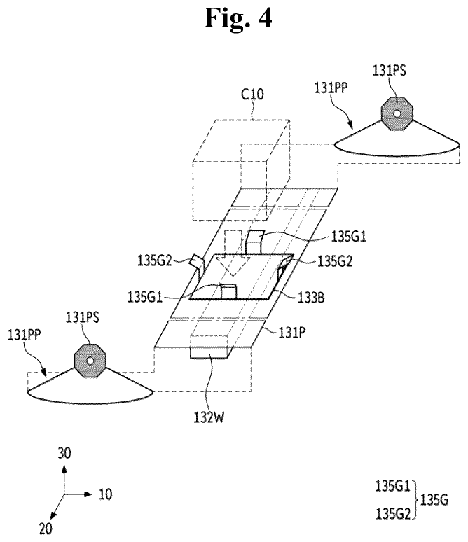

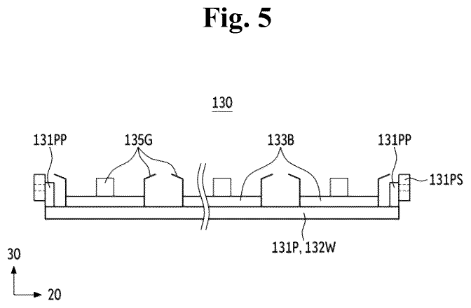

FIG. 1 is a front view illustrating an article storage system according to the first embodiment of the present disclosure, FIG. 2 is a front view illustrating a rotation unit and a shelf module of an article storage system according to the first embodiment of the present disclosure, and FIG. 3 is a front view illustrating a shelf module of an article storage system according to the first embodiment of the present disclosure. In addition, FIG. 4 is a perspective view illustrating a shelf module of an article storage system according to the first embodiment of the present disclosure, and FIG. 5 is a side view illustrating a shelf module of an article storage system according to the first embodiment of the present disclosure.

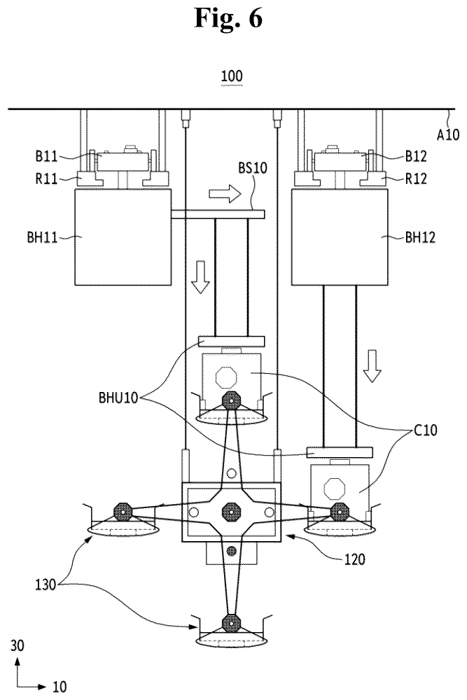

Also, FIG. 6 is a front view illustrating a loading and unloading work according to a first form of an article storage system according to the first embodiment of the present disclosure.

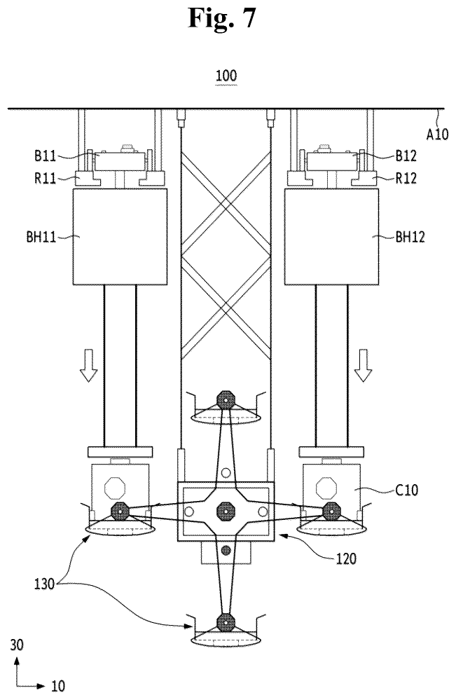

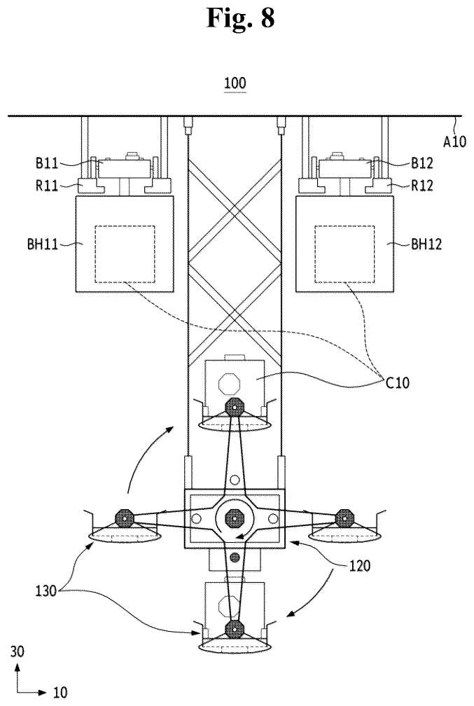

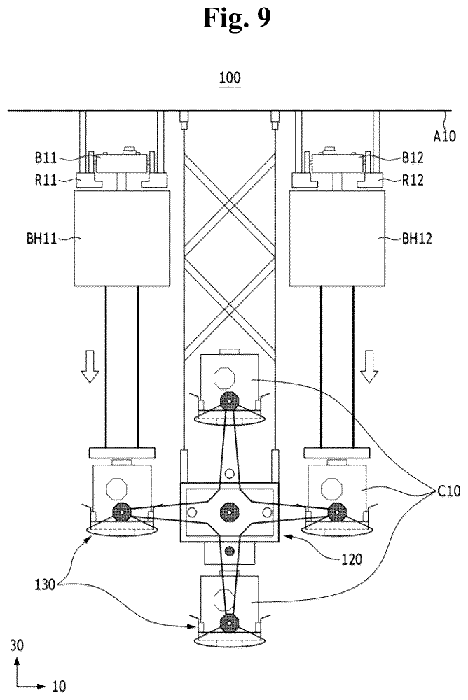

In addition, FIG. 7 is a front view illustrating a loading and unloading work according to a second form of an article storage system according to the first embodiment of the present disclosure, FIG. 8 is a front view illustrating a state in which a rotation unit is rotated in an article storage system according to the first embodiment of the present disclosure, and FIG. 9 is a front view illustrating a state in which an additional loading and unloading work according to a second form of an article storage system according to the first embodiment of the present disclosure is performed.

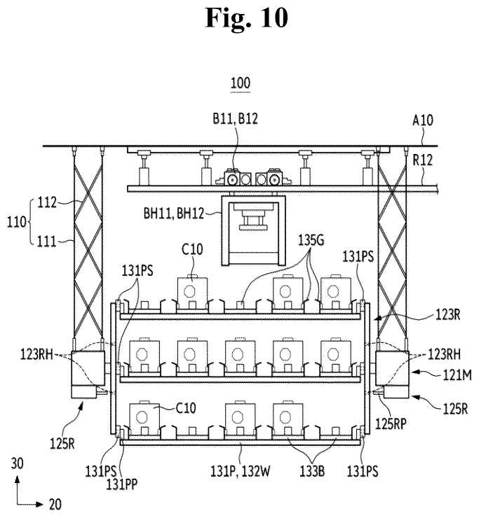

Furthermore, FIG. 10 is a side view illustrating an article storage system according to the first embodiment of the present disclosure.

Referring to FIGS. 1 to 10, an article storage system 100 according to an embodiment of the present disclosure may be provided to a manufacturing plant that manufactures a semiconductor (or a display). The manufacturing plant may be provided with a plurality of fabrication facilities (fabs).

The plurality of fabs may be provided as clean rooms, and a plurality of substrate treating apparatuses for performing a semiconductor manufacturing process may be installed therein. The plurality of substrate treating apparatuses performs a plurality of manufacturing processes such as a depositing process, a lithography process, and an etching process on a substrate (e.g., a wafer).

In a series of processes in the manufacturing plant, after the manufacturing process is performed in any one semiconductor substrate treating apparatus, an article such as a substrate and/or a reticle may be transferred to another semiconductor substrate treating apparatus for the next manufacturing process. In this case, the substrate may be transferred while being stored in a container C10 capable of accommodating a plurality of substrates.

In addition, the semiconductor substrate treating apparatuses may have different substrate treating capabilities and processing times. To solve a problem occurring due to such different substrate treating capabilities and processing times, the container C10 may be transferred to the article storage system 100 for temporarily storing the container C10.

The container C10 transferred from the manufacturing plant may be a Front Open Unifies POD (FOUP), a Front Opening Shipping Box (FOSB), a Multi Application Carrier (MAC) and/or a POD, which accommodate(s) articles such as reticles, substrates and/or semiconductor chips.

The transfer of the container C10 may be performed by vehicles B11 and B12. In order for an article to be transferred between the plurality of substrate treating apparatuses and/or to the article storage system 100 or to be transferred to the plurality of fabs, a rail unit (e.g., a first rail R11 and a second rail R12) may form a moving path. The vehicles B11 and B12 may move along the moving path formed by the rail unit.

That is, the moving path may be formed as a transfer path for transferring the article between the plurality of substrate treating apparatuses or to the article storage system 100, and the moving path may form an installation path of the rail unit. For example, the rail unit may be provided on the ceiling.

The vehicles B11 and B12 may be provided as overhead hoist transports, automated guided vehicles, and/or rail guided vehicles. The vehicles B11 and B12 may include not only a structure for driving, but also housings BH11 and BH12 with open sides and lower portions, a hand unit BHU10 for holding a container, and a vehicle driving module BS10 for sliding and/or elevating the hand unit BHU10. The hand unit BHU10 of the vehicles B11 and B12 may slide in a horizontal direction and then ascend or descend, or may ascend or descend without sliding, thereby loading and unloading the container C10.

Hereinafter, the rail unit in which the moving path of the vehicles B11 and B12 is provided is an example in which a plurality of rails are provided, and it will be described that the first rail R11 and the second rail R12, which are adjacent to each other, are provided for convenience of description and understanding. Various modifications may be made in the first rail R11 and the second rail R12 like that the first vehicle B11 moving through the first rail R11 and the second vehicle B12 moving through the second rail R12 are provided to move in the same direction or in opposite directions.

The article storage system 100 may be provided so that the first vehicle B11 and the second vehicle B12, which move through the first rail R11 and the second rail R12, perform a loading and unloading work of the container C10 without interfering with each other.

That is, in the article storage system 100 according to some embodiments, the container C10 in which an article such as a wafer, a chip, and/or a reticle is stored may be stored. For example, the article storage system 100 is provided as a structure in which functions of the side track buffer and the under track buffer are combined, that is, is provided to enable the loading and unloading work of the container C10 from lower portions and sides of the vehicles B11 and B12, thereby improving space efficiency of the manufacturing plant and improving efficiency in the loading and unloading work of the vehicles B11 and B12 as transfer devices.

The article storage system 100 according to some embodiments may include a support unit 110, a rotation unit 120, and a shelf module 130.

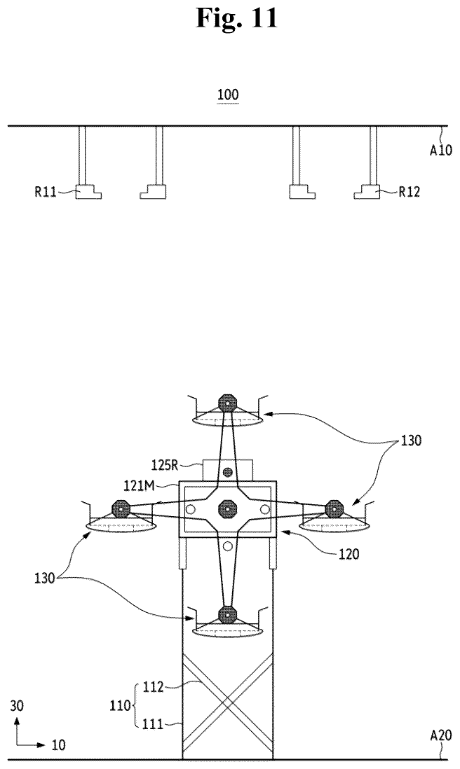

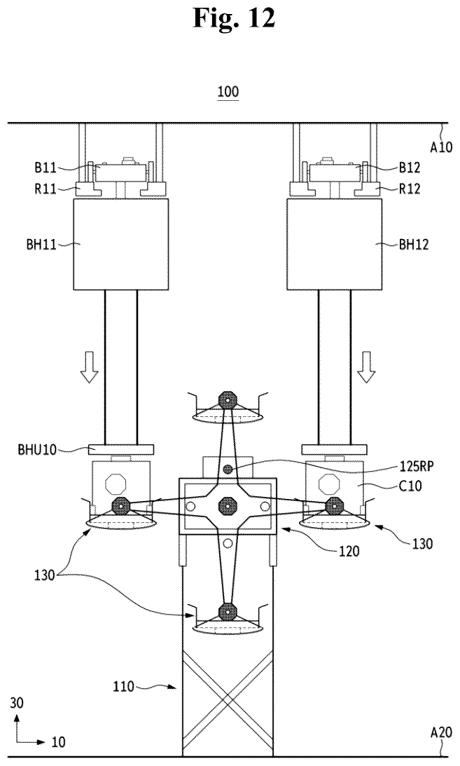

The support unit 110 may be perpendicular to an installation surface. The installation surface of the first embodiment may be provided as a ceiling A10 of the semiconductor manufacturing plant. In this case, the support unit 110 may extend downward from the ceiling A10. Another example of the installation surface will be described with reference to FIGS. 11 and 12.

The support unit 110 may be provided between the first rail R11 and the second rail R12 in which moving paths of the vehicle B11 and B12 are formed. In other words, the support unit 110 may be provided so that two vehicles (e.g., the first vehicle B11 and the second vehicle B12) may simultaneously perform the loading and unloading work on both sides of the support unit 110.

The support unit 110 according to some embodiments may include a column 111 and a brace 112.

The column 111 may be provided in plural as a structure having a length, and may be provided as, for example, a bar and/or a rod. That is, the column 111 is implemented as a structure extending from the installation surface to the position where the container C10 is loaded, and may be provided so that when the vehicles B11 and B12 load and unload the container C10, the container C10 is loaded on the shelf module 130, that is, a level of the shelf module 130 is easily set for the loading and unloading work. However, the level and position of the shelf module 130 may be changed by the operation of the rotation unit 120.

The column 111 of the support unit 110 may be provided as, for example, four columns 111 located at each vertex of a virtual square based on a plan view. However, three or two columns 111 may be provided as elements for supporting the rotation unit 120. In this way, various modifications may be made in the column 111 like that the column 111 is provided to rotate the rotation unit 120.

The brace 112 may connect a plurality of columns 111 to reinforce the structure of the column 111 and/or reduce/prevent shaking. For example, the brace 112 is provided in an ‘X’ shape across the plurality of columns 111 to implement a structure in which the plurality of columns 111 are connected to each other so that adjacent columns 111 are constrained to each other by the brace 112 to reduce and reinforce shaking as compared to that the plurality of columns 111 has an individual cantilever structure, but this is only exemplary and thus is not limited thereto.

The rotation unit 120 is a medium connecting the support unit 110 to the shelf module 130, and may be implemented such that the position and level of the shelf module 130 are changed while supporting the shelf module 130.

The rotation unit 120 according to some embodiments may be provided to be axially rotated on the support unit 110. For example, the rotation unit 120 may include a motor 121M, a rotor 123R, and/or a lock module 125R.

The motor 121M may be driven by electricity by receiving power by a battery and/or a cable provided as an external power line, and when the cable is connected, the cable may be provided by being fixed to the column 111 of the support unit 110 by a structure such as a bracket. The motor 121M may be provided with a shaft connected to the rotor 123R for rotation of the rotor 123R, which may have the same structure as that of an electric motor that is known.

As shown in FIGS. 1 and 10, the motor 121M may be connected to an end of the column 111 and installed on the installation surface by the column 111, and is provided at both ends of the shelf module 130 in a longitudinal direction, respectively, so that a pair of motors 121M may be synchronized to rotate the rotor 123R.

The motor 121M is provided with a reducer and an encoder so that a rotation speed may be controlled, and the number of rotations may be sensed/measured, thereby controlling a rotation angle of the rotor 123R to be rotated at a set angle.

For example, the motor 121M may be operated so that the first vehicle B11 and the second vehicle B12 perform the loading and unloading work as shown in FIG. 7, and then the rotor 123R rotates at an angle of 45° so that the first vehicle B11 and/or the second vehicle B12 may perform the loading and unloading work for an empty shelf base 133B as shown in FIG. 8. Then, as shown in FIG. 9, the container C10 may be loaded on the empty shelf base 133B.

However, this is only an operation form according to an example, and the first vehicle B11 and/or the first vehicle B11 may perform the loading and unloading work by performing a sliding operation in a lateral direction as shown in FIG. 6 as well as the loading and unloading work in a downward direction. In other words, the first vehicle B11 and/or the second vehicle B12 may perform the work to load the container C10 on the empty shelf base 133B. Accordingly, the motor 121M may rotate the rotor 123R at various angles, such as 90°, 180°, and/or −45°, −90°, without being limited to an angle of 45° depending on the position of the shelf base 133B on which the container C10 is loaded or the container C10 is empty.

The rotor 123R may be connected to the motor 121M and rotated by driving of the motor 121M. Unlike the shelf plate 131P that rotates idle, the rotor 123R may be connected to a shaft of the motor 121M by a bearing, so that it rotates in conjunction with the shaft of the motor 121M, and thus the rotated angle may be changed depending on the operation of the motor 121M.

However, various modifications may be made in the rotor 123R like that an electronic brake 131PS is provided between the rotor 123R and the motor 121M so that the rotor 123R may be stopped regardless of the operation of the motor 121M by an operation of the electronic brake 131PS during an error operation of the motor 121M.

The rotor 123R of some embodiments may be provided with an extension arm 123RA extending in a radial direction, and one or more through holes 123RH may be formed therein.

For example, the extension arm 123RA may include a first arm 123RA1, a second arm 123RA2, a third arm 123RA3, and a fourth arm 123RA4.

The first arm 123RA1 may form a reference of a direction. In this case, the reference of the direction is set/defined for description and convenience, and referring to FIG. 2, for example, the reference of the direction in which the first arm 123RA1 is formed may be a left side based on the drawing, but this is to describe the extension arm 123RA extending in four directions. The extension arm 123RA extending in a left direction is not limited to the first arm 123RA1, and since the first arm 123RA1 may be an extension arm 123RA extending to a right side, a left side, or a lower side, the reference of the direction may be the right side, the upper side, or the lower side.

The second arm 123RA2 may extend in a direction opposite to the first arm 123RA1. For example, when the first arm 123RA1 is defined as an extension arm 123RA extending to the left side, the second arm 123RA2 may be defined as an extension arm 123RA extending to the right side, which is the opposite direction of the left side.

The third arm 123RA3 may extend in a direction orthogonal to the first arm 123RA1. For example, when the first arm 123RA1 is defined as an extension arm 123RA extending to the left side, the third arm 123RA3 is an extension arm 123RA extending in a direction orthogonal to the first arm 123RA1, and may be defined as an extension arm 123RA extending upward.

The fourth arm 123RA4 may extend in a direction orthogonal to the first arm 123RA1 while forming a direction opposite to the third arm 123RA3. For example, when the first arm 123RA1 is defined as an extended arm 123RA1 extending to the left side, the fourth arm 123RA4 is an extended arm 123RA which is orthogonal to the first arm 123RA1 and extends in a direction opposite to the third arm 123RA3, and may be defined as an extended arm 123RA1 extending downward.

In other words, there are four extension arms 123RA in four directions, each of which may be provided at an interval of 45°, and the positions of the first arm 123RA1, the second arm 123RA2, the third arm 123RA3 and the fourth arm 123RA4 may vary depending on the rotation of the rotor 123R.

The through hole 123RH is an element provided to physically block the rotation of the rotor 123R by the lock module 125R, and may be provided so that a fixing pin 125RP of the lock module 125R interferes with the through hole 123RH of any one of the plurality of extension arms 123RA regardless of the rotation angle of the rotor 123R, that is, the positions of the first arm 123RA1, the second arm 123RA2, the third arm 123RA3 and the fourth arm 123RA4.

To this end, the through hole 123RH may be formed in each extension arm 123RA, that is, the through hole 123RH may be formed in each of the first arm 123RA1, the second arm 123RA2, the third arm 123RA3 and the fourth arm 123RA4. Accordingly, the fixing pin 125RP of the lock module 125R faces each extension arm 123RA1 regardless of the positions of the first arm 123RA1, the second arm 123RA2, the third arm 123RA3 and the fourth arm 123RA4 depending on the rotation position of the rotor 123R, so that the fixing pin 125RP may be inserted into the through hole 123RH at a position facing the fixing pin 125RP, thereby physically blocking the rotation of the rotation body 123R.

The lock module 125R is an element of blocking the rotation of the rotor 123R together with or individually from the electronic brake 131PS that electrically blocks the rotation of the rotor 123R. The fixing pin 125RP of the lock module 125R may be inserted into the through hole 123RH to physically block the rotation of the rotor 123R, or the fixing pin 125RP may be spaced apart from the through hole 123RH to allow the rotation of the rotor 123R.

For example, the lock module 125R may be provided as an actuator that uses a pneumatic or hydraulic pressure to adjust a protruding length of the fixing pin 125RP inserted into or spaced apart from the through hole 123RH, but this is only exemplary. That is, various modifications, which physically block the rotation of the rotor 123R, such as a motor and/or ball screw mechanism operated by electromagnetic interaction, may be made in the lock module 125R.

In addition, the lock module 125R may be provided as a pair of lock modules adjacent to a pair of motors 12M, so that the rotation may be stopped at both ends of the shelf module 130.

The shelf module 130 may be provided in the rotation unit 120 so that its arrangement is changed in conjunction with the rotation of the rotation unit 120, and the container C10 may be accommodated therein.

For example, the shelf module 130 may include a shelf plate 131P, a weight 132W, a shelf base 133B, and a guider 135G.

The shelf plate 131P may rotate idle in the extension arm 123RA. For example, the shelf plate 131P may be provided as a rectangular plate extending in a longitudinal direction of the first rail R11 and/or the second rail R12 between a pair of motors 121M.

In addition, the shelf plate 131P may be provided in a structure that it is easily connected to the extension arm 123RA. For example, referring to FIGS. 3 and 4, the shelf plate 131P may be bent at a right angle, or may be provided with a connection plate 131PP connected at a right angle.

The connection plate 131PP may have a fan shape as an example, but this is only exemplary, and thus is not limited thereto. When the connection plate 131PP is provided, the connection plate 131PP may be connected to the extension arm 123RA to rotate idle, and since the electronic brake 131PS may be provided between the extension arm 123RA and the connection plate 131PP, the electronic brake 131PS may be installed on one surface (or the other surface) of the connection plate 131PP.

The weight 132W may minimize shaking of the rotor 123R when the rotor 123R is rotated while one surface of the shelf plate 131P forms a lower surface regardless of the rotation of the rotor 123R.

For example, the weight 132W may be located at the center on one surface of the shelf plate 131P. For example, the weight 132W may be provided integrally with the shelf plate 131P to form a single structure, but is not limited thereto, and various modifications may be made in the weight 132W like that the weight 132W may be detachably attached to the shelf plate 131P by a magnetic force and/or a bolting method.

In addition, the weight 132W may be provided in the form of one long bar, but is not limited thereto, and various modifications may be made in the weight 132W like that multiple blocks may be connected in a line or provided along a longitudinal direction of the shelf plate 131P at intervals.

The shelf base 133B may be provided on an upper surface, which is the other surface of the shelf plate 131P, and the container C10 may be loaded thereon. The shelf base 133B may be provided to correspond to a shape/size of the container C10 such that one container C10 is loaded thereon, but is not limited thereto. The shelf base 133b may be provided with a length corresponding to a plurality of containers C10 such that the plurality of containers C10 are loaded on one shelf base 133B.

The guider 135G extends upward from the shelf base 133B, and its upper end portion may be bent outward to guide the seating of the container C10. For example, the guider 135G may include a first guide plate 135G1 paired at the front and rear of the container C10, and a second guide plate 135G2 paired at the left and right sides of the container C10.

The shelf module 130 of some embodiments may be provided at a position facing the lower portion of each of the first rail R11 and the second rail R12 in an up and down direction so that the container C10 loaded and unladed from one or more vehicles B11 and B12 moving through each of the first rail R11 and the second rail R12 is loaded thereon.

That is, the shelf module 130 may be provided on each of the first arm 123RA1 and the second arm 123RA2. In addition, the rotor 123R may rotate to change the arrangement of the first arm 123RA1 and the second arm 123RA2 of the left and right sides in directions of upper and lower sides, respectively. At this time, the shelf module 130 may be provided not only for the first arm 123RA1 and the second arm 123RA2 but also for the third arm 123RA3 and the fourth arm 123RA4, so that the lower portion of each of the first rail R11 and the second rail R12 faces another shelf module 130 in an up and down direction.

In other words, the shelf plate 131P may be provided in each of the first arm 123RA1, the second arm 123RA2, the third arm 123RA3 and the fourth arm 123RA4 to rotate idle so that the vehicles B11 and B12 load and unload the container C10 on and from the shelf base 133B regardless of the rotation state of the rotor 123R.

The electronic brake 131PS may be provided in the rotor 123R so that the rotation of the rotor 123R rotated by the motor 121M is stopped. For example, the electronic brake 131PS may be provided at the center of the rotor 123R, which is a position facing the motor 121M, so that the rotation of the rotor 123R by the motor 121M is stopped.

The electronic brake 131PS may be provided in the rotor 123R so that the rotation of the shelf plate 131P rotated in the rotor 123R is stopped. For example, the electronic brake 131PS may be provided between the rotor 123R and the shelf plate 131P, and thus may be provided at a position facing the shelf plate 131P in each of the four extension arms 123RA.

The electronic brake 131PS may be operated to correspond to an error operation of the motor 121M, but is not limited thereto. The electronic brake 131PS may be provided to stop the idle rotation of the shelf plate 131P after the rotation of the rotor 123R is completed, that is, during a normal time when the rotor 123R does not rotate, thereby minimizing shaking of the container C10 by an external force such as a collision.

The electronic brake 131PS may be provided as, for example, a brake driving unit that rotates a disk so that the disk, a rotational shaft spaced apart from the disk, and a portion of a circumferential surface of the disk are in close contact with a main body (external appearance not a shaft) of the rotor 123R and/or the motor 121M to generate a braking force. However, this is only exemplary and thus is not limited thereto.

Although not shown in the drawing, the shelf module 130 is provided with a loading sensor that detects a loading state of the container C10 and an RFC to determine a loading and unloading state of the container C10 in a control device that controls the entire manufacturing plant including the vehicles B11 and B12. In this case, a known mechanism may be applied.

The loading sensor is a sensor that detects the loading state of container C10, and for example, when the container C10 is loaded, light reception of a laser is blocked, so that the loading sensor may detect that the container C10 is loaded. Alternatively, the loading sensor may detect whether the container C10 is seated by detecting a pressure change or a load. In this way, the type of the loading sensor is not limited.

In addition, the shelf module 130 may be provided with an alignment pin and/or a guide block that may be fitted into a groove of the container C10 to align the container C10 or prevent shaking.

As another modified example, the installation surface may be provided as a bottom surface A20 of the semiconductor manufacturing plant. At this time, the support unit 110 may extend upward from the bottom surface A20.

Hereinafter, a modified example of the present embodiment will be described with reference to FIGS. 11 and 12, and redundant descriptions of the same elements performing the same function will be omitted.

FIG. 11 is a front view illustrating an article storage system according to the second embodiment of the present disclosure, and FIG. 12 is a front view illustrating a loading and unloading work of an article storage system according to the second embodiment of the present disclosure. Referring to FIGS. 11 and 12, the following description will be based on differences from those described with reference to FIGS. 1 to 10.

Referring to FIGS. 11 and 12, the article storage system 100 according to the second embodiment may include a support unit 110, a rotation unit 120, and a shelf module 130 in the same/similar manner as/to the first embodiment.

However, the second embodiment differs from the first embodiment in that the installation surface on which the support unit 110 is installed is provided as the bottom surface A20 of the semiconductor manufacturing plant. In this case, the support unit 110 may extend upward from the bottom surface A20.

That is, the second embodiment differs from the first embodiment in that the column 111 of the support unit 110 is provided to extend upward from the bottom surface A20. The second embodiment is the same as/similar to the first embodiment in a structure in which a plurality of columns 111 are reinforced by the brace 112, and the motor 121M may be installed at the end (e.g., the top) of the column 111.

In the same/similar manner as/to the first embodiment, the shelf module 130 of the second embodiment may be empty by rotation by the rotation unit 120 or the position of the shelf base 133B on which the container C10 is loaded may be changed.

Since the structure and/or the operation of the rotation unit 120 and the shelf module 130 according to the second embodiment are the same as/similar to the first embodiment, repeated descriptions will be omitted.

In the article storage system 100 according to some embodiments of the present disclosure, two vehicles B11 and B12 at the same position in the left-right direction based on FIGS. 1 and 11, that is, the first vehicle B11 located on the first rail R11 and the second vehicle B12 located on the second rail R12 may simultaneously perform the loading and unloading work, thereby improving efficiency in the loading and unloading work and minimizing/preventing delay in the transfer work due to the efficiency in the loading and unloading work. As a result, since congestion of the vehicles B11 and B12 may be reduced, the system may operate efficiently throughout the manufacturing plant.

In addition, the article storage system 100 is provided with functions of a side track buffer and an under track buffer, that is, the effect of providing two storage structures through one article storage system 100 is created, so that installation/manufacturing costs may be reduced by sharing the support unit 110 installed on the installation surface, and space efficiency of the manufacturing plant may be improved.

Although the embodiments of the present disclosure have been described with reference to the accompanying drawings, it will be apparent to those skilled in the art that the present disclosure can be manufactured in various forms without being limited to the above-described embodiments and can be embodied in other specific forms without departing from the technical spirits and essential characteristics. Thus, the above embodiments are to be considered in all respects as illustrative and not restrictive.

What is claimed is:

1. An article storage system in which a container in which an article is stored is stored, the article storage system comprising:
a support unit perpendicular to an installation surface;
a rotation unit rotated axially in the support unit; and
a shelf module provided in the rotation unit so that its arrangement is changed in conjunction with rotation of the rotation unit, accommodating the container.

2. The article storage system of claim 1, wherein the rotation unit includes:
a motor; and
a rotor rotated by being connected to the motor.

3. The article storage system of claim 2, wherein the rotor is provided with an extension arm extending in a radial direction.

4. The article storage system of claim 3, wherein the extension arm includes:
a first arm constituting a reference;
a second arm extending in a direction opposite to the first arm;
a third arm extending in a direction orthogonal to the first arm; and
a fourth arm extending in a direction orthogonal to the first arm while forming a direction opposite to the third arm.

5. The article storage system of claim 4, wherein the first arm, the second arm, the third arm and the fourth arm are spaced apart from one another at an interval of 45°.

6. The article storage system of claim 3, wherein the shelf module includes:
a shelf plate rotated idle in the extension arm; and
a weight located at the center on a lower surface of the shelf plate.

7. The article storage system of claim 6, wherein the rotation unit further includes an electronic brake provided in the rotor to stop rotation of the rotor rotated by the motor or provided in the rotor to stop rotation of the shelf plate rotated in the rotor.

8. The article storage system of claim 6, wherein the shelf module further includes a shelf base provided on an upper surface of the shelf plate, loading the container thereon.

9. The article storage system of claim 8, wherein the shelf module further includes a guider extending upward from the shelf base, having an upper end portion bent outward to guide seating of the container.

10. The article storage system of claim 9, wherein the guider includes:
a first guide plate paired at the front and rear of the container; and
a second guide plate paired on left and right sides of the container.

11. The article storage system of claim 2, wherein the rotor is provided with one or more through holes, and
the rotation unit further includes a lock module inserted into the through hole to block rotation of the rotor or spaced apart from the through hole to allow the rotation of the rotor.

12. The article storage system of claim 11, wherein the lock module is provided as an actuator that operates at a pneumatic or hydraulic pressure to adjust a protruding length of a fixing pin inserted into or spaced apart from the through hole.

13. The article storage system of claim 1, wherein the installation surface is provided as a ceiling of a semiconductor manufacturing plant, and
the support unit extends downward from the ceiling.

14. The article storage system of claim 1, wherein the installation surface is provided as a bottom surface of a semiconductor manufacturing plant, and
the support unit extends upward from the bottom surface.

15. The article storage system of claim 1, wherein the support unit includes:
a plurality of columns; and
a brace connecting the plurality of columns.

16. The article storage system of claim 1, wherein the support unit is provided between a first rail on which a vehicle's moving path is formed and a second rail on which another moving path is formed adjacent to the first rail.

17. The article storage system of claim 16, wherein the shelf module is provided at a position facing a lower portion of each of the first rail and the second rail in an up and down direction so that the container loaded and unloaded from one or more vehicles moving through each of the first rail and the second rail is loaded.

18. An article storage system in which a container in which an article is stored is stored, the article storage system comprising:
a support unit perpendicular to a ceiling in a downward direction;
a rotation unit rotated axially in the support unit; and
a shelf module provided in the rotation unit so that its arrangement is changed in conjunction with rotation of the rotation unit, accommodating the container,
wherein the rotation unit includes:
a motor rotated at an interval of 45°; and
a rotor rotated by being connected to the motor and provided with an extension arm extending in four directions,
the shelf module includes:
a shelf plate rotated idle in the extension arm; and
a shelf base on which the container is loaded, and
the shelf base is provided at a position facing a lower portion of each of a first rail and a second rail adjacent to the first rail in an up and down direction and provided in an up and down direction between the first rail and the second rail, so that the container loaded and unloaded from one or more vehicles moving through each of the first rail and the second rail is loaded.

19. An article storage system in which a container in which an article is stored is stored, the article storage system comprising:
a support unit perpendicular to a ceiling in a downward direction and provided between a first rail in which a vehicle's moving path is formed and a second rail in which another moving path is formed adjacent to the first rail;
a rotation unit rotated axially in the support unit; and
a shelf module provided in the rotation unit so that its arrangement is changed in conjunction with rotation of the rotation unit, accommodating the container,
wherein the rotation unit includes:
a motor rotated at an interval of 45°;
a rotor rotated by being connected to the motor and provided with an extension arm including a first arm, a second arm, a third arm and a fourth arm, which are provided in a radial direction, arranged at an interval of 45° and provided with a through hole;
an electronic brake provided in the rotor to stop rotation of the rotor rotated by the motor or provided in the rotor to stop rotation of the shelf module rotated in the rotor; and
a lock module provided with a fixing pin and inserted into the through hole in accordance with an elongation of the fixing pin to block the rotation of the rotor, or spacing the fixing pin apart from the through hole to allow the rotation of the rotor, and
the shelf module includes:
a shelf plate rotated idle in the extension arm;
a shelf base including a weight located at the center on a lower surface of the shelf plate, provided on an upper surface of the shelf plate, loading the container thereon; and
a guider extending upward from the shelf base, having an upper end portion bent outward to guide seating of the container, and including a first guide plate paired at the front and rear of the container and a second guide plate paired on left and right sides of the container.
